(19) United States
(12) Patent Application Publication
(10) Pub. No.: US 2012/0188785 A1
(43) Pub. Date: Jul. 26, 2012

(54) LIGHT GUIDE BODY AND LIGHT SOURCE ASSEMBLY USING SAME

(75) Inventor: YUNG-LUN HUANG, Tu-Cheng (TW)

(73) Assignee: HON HAI PRECISION INDUSTRY CO., LTD., Tu-Cheng (TW)

(21) Appl. No.: 13/071,522

(22) Filed: Mar. 25, 2011

(30) Foreign Application Priority Data
Jan. 26, 2011 (TW) 100102776

(51) Int. Cl. G02B 6/00; F21V 8/00

(52) U.S. Cl. 362/551; 362/317

(57) ABSTRACT

A light guide body has a light guide block having a light incident side and an opposite light emitting side, the light guide block includes an inwardly curved surface, two toothed surfaces at opposite sides of the inwardly curved surface, and a light emitting surface located at the light emitting side. The toothed surfaces each has a number of teeth, with widths of bottom sides of the teeth descending in a geometric sequence with a common ratio greater than 0 and less than 1 in a direction away from the inwardly curved surface. The inwardly curved surface and the toothed surfaces are located at the light incident side. A light source assembly using the light guide body is also provided.

### BACKGROUND

1. Technical Field

The present disclosure relates to light guide bodies and light source assemblies using such light guide bodies.

2. Description of Related Art

Light guide bodies are widely used for guiding light in an attempt to achieve uniform light output by apparatus using the light guide bodies. However, light guide bodies only have concave-convex structures formed internally, which cannot provide a satisfied level of uniformity.

What is needed, therefore, is a light guide body and a light source assembly, which can overcome the above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic isometric view of a light guide body in accordance with one embodiment.

FIG. 2 is a schematic view of a light source assembly in accordance with one embodiment, the light source assembly including a light source and a light guide body.

### DETAILED DESCRIPTION

Embodiments of the present light guide body and light source assembly will now be described in detail below and with reference to the drawings.

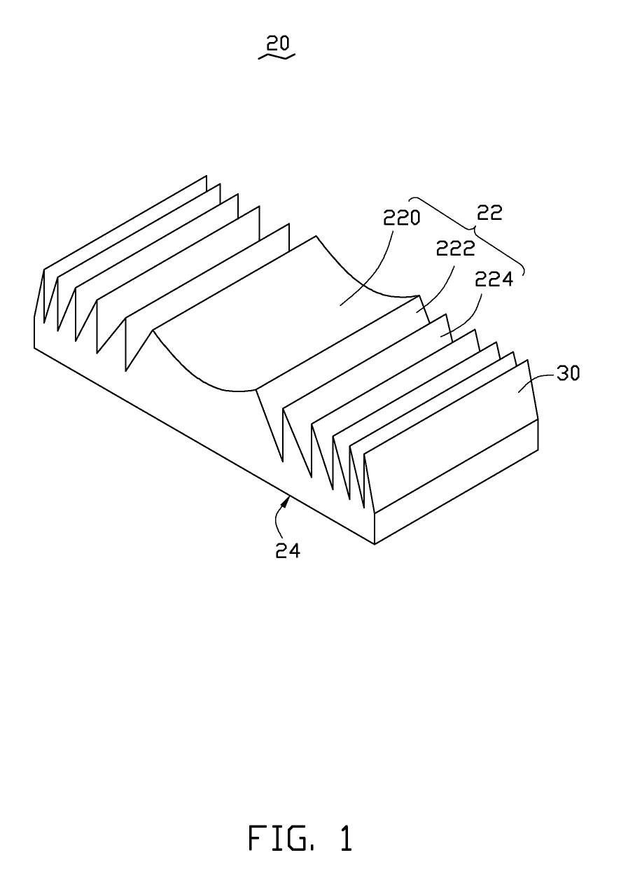

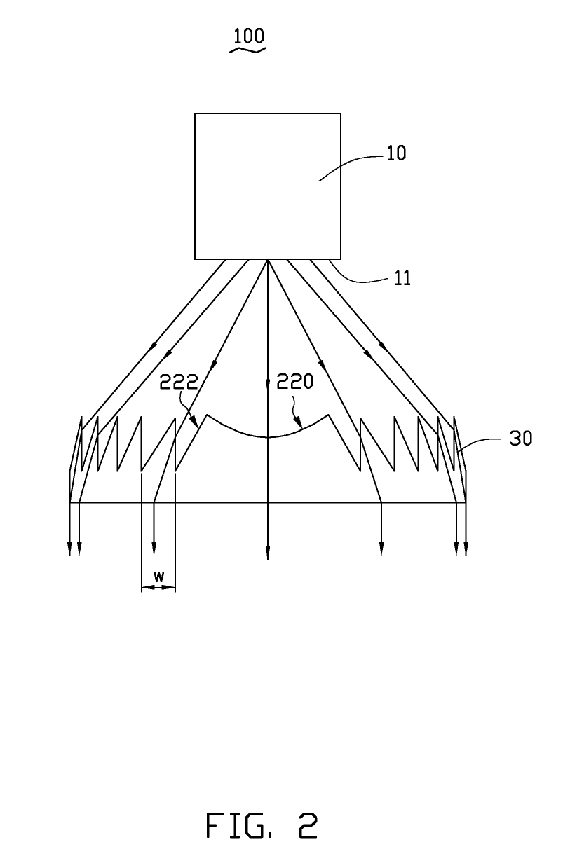

Referring to FIGS. 1 and 2, a light source assembly 100 includes a light source 10 and a light guide body 20. In the present embodiment, the light source 10 is a single LED point light source. The light guide body 20 includes a light incident surface 22 and a light emitting surface 24 opposite to the light incident surface 22. In the present embodiment, the light guide body 20 is in a block shape, with a length of the light guide body 20 is greater than a width of the light guide body 20.

The light incident surface 22 includes an inwardly curved surface 220, two slanted surfaces 222 extending from the inwardly curved surface 220, and two toothed surfaces 224 respectively extending from the slanted surfaces 222. The inwardly curved surface 220 faces the center of the light source 10 and receives a central part of light beams emitted from the light source 10, such that normal incidence substantially occurs at the inwardly curved surface 220 and oblique incidence substantially occurs at the slanted surfaces 222 and at the toothed surfaces 224.

The inwardly curved surface 220 is a symmetrical structure about a central axis thereof, that is, the central axis is at a lowest position of the inwardly curved surface 220, and two opposite sides are at a highest position. The slanted surfaces 222 extend outwardly from the two opposite sides of the inwardly curved surface 220, and are symmetrical about the central axis of the inwardly curved surface 220. The toothed surfaces 224 are also symmetrical about the central axis of the inwardly curved surface 220.

Each toothed surface 224 includes a plurality of teeth 30 connected one by one. In the present embodiment, each tooth 30 is substantially in a rectangular triangle shape, and the rectangular side of the tooth 30 is nearer to the inwardly curved surface 220 relative to the hypotenuse of the tooth. The teeth 30 are all substantially a same height, and the tooth tips are slightly lower than the highest position of the inwardly curved surface 220.

For each toothed surface 224, the bottom sides of the teeth, i.e., the sides connecting ends of the rectangular sides and ends of the hypotenuses become narrower according to a common ratio geometric sequence from the inwardly curved surface 220 to a periphery of the light guide body 20, with the common ratio less than 1 and greater than 0. That is, the teeth 30 of the toothed surface 224 are smaller and smaller in a direction away from the inwardly curved surface 220. The smaller the teeth 30, the greater the reflection and refraction are, such that the light output from the light guide body 20 will be more uniform. An example of the geometric sequence in use has a width of a bottom side of a tooth 30 at 1 mm, and the common ratio q is 0.2, then that the width of the next tooth 30 farther away from the slanted surface 222 is 0.2 mm. Furthermore, a width w of the bottom side of the tooth 30 closest to the slanted surface 222 is substantially the common ratio times the width of a light emitting surface 11 of the light source 10. For example, if the width w of the light emitting surface 11 is 5 mm, and the q is 0.2, then the width of the bottom side of the tooth 30 closest to the inwardly curved surface 220 is 5*0.2=1 mm.

The light emitting surface 24 is a flat surface. In the illustrated embodiment, the light source 10 and the light guide body 20 are arranged in the manner that the light beams output from the light emitting surface 24 are substantially perpendicular to the light emitting surface 24. In addition, to avoid light loss, the light guide body 20 is placed in a position that ensures the light incident surface 22 of the light guide body 20 receives the most light beams emitted from the light source 10.

Additional pairs of the light source 10 and light guide body 20 can be combined together to achieve a larger illuminating field.

With the above configuration, the light output from the light guide body 20 is substantially uniform.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A light guide body comprising a light guide block having a light incident side and an opposite light emitting side, the light guide block comprising:
an inwardly curved surface,
two toothed surfaces at opposite sides of the inwardly curved surface, the toothed surfaces each having a plurality of teeth, widths of bottom sides of the teeth descending in a geometric sequence with a common ratio greater than 0 and less than 1 in a direction away from the inwardly curved surface, the inwardly curved surface and the toothed surfaces located at the light incident side; and
a light emitting surface located at the light emitting side.

2. The light guide body of claim 1, further comprising two slanted surfaces each interconnected between the inwardly curved surface and corresponding toothed surface, the slanted surfaces slanted relative to the light emitting surface.

3. The light guide body of claim 2, wherein the light emitting surface is a flat surface.

4. The light guide body of claim 3, wherein a height of each of the teeth of the toothed surfaces with respect to the light emitting surface is less than that of the inwardly curved surface.

5. The light guide body of claim 1, wherein the inwardly curved surface is symmetrical about a central axis of the light guide block.

6. The light guide body of claim 1, wherein the toothed surfaces are symmetrical about a central axis of the light guide block.

7. A light source assembly comprising:
a light source; and
a light guide body of claim 1, wherein the inwardly curved surface is configured for receiving a central part of a light beam emitted from the light source, and the toothed surfaces are configured for receiving a peripheral part of the light beam emitted from the light source.

8. The light source assembly of claim 7, further comprising two slanted surfaces each interconnected between the inwardly curved surface and corresponding toothed surface, the slanted surfaces slanted relative to the light emitting surface.

9. The light source assembly of claim 8, wherein the light emitting surface is a flat surface configured for emitting light in a direction substantially perpendicular to the light output surface.

10. The light source assembly of claim 7, wherein a ratio of the width of the bottom side of each of the two teeth closest to the inwardly curved surface to the width of a light emitting surface of the light source is equal to the common ratio.
